(19) United States
(12) Patent Application Publication
(10) Pub. No.: US 2021/0064967 A1
(43) Pub. Date: Mar. 4, 2021

(54) MODULAR DISTRIBUTED ARTIFICIAL NEURAL NETWORKS

(71) Applicant: ANTS TECHNOLOGY (HK) LIMITED, Wanchai (HK)

(72) Inventors: Pavel NOSKO, Yavne (IL); Alex Rosen, Ramat Gan (IL); Ilya Blayvas, Rehovot (IL); Gal Perets, Mazkeret Batya (IL); Ron Fridental, Shoham (IL)

(21) Appl. No.: 17/075,733

(22) Filed: Oct. 21, 2020

Related U.S. Application Data
(63) Continuation of application No. 15/672,328, filed on Aug. 9, 2017.

(51) Int. Cl. G06N 3/04; G06N 3/08

(52) U.S. Cl. CPC G06N 3/0454; G06N 3/082; G06N 3/08

(57) ABSTRACT

A modular neural network system comprising: a plurality of neural network modules; and a controller configured to select a combination of at least one of the neural network modules to construct a neural network, dedicated for a specific task.

### REFERENCES

[VGG] K. Simonyan, A. Zisserman Very Deep Convolutional Networks for Large-Seale Image Recognition ICLR 2015.

[PathNet] Evolution Channels Gradient Descent in Super Neural Networks.

### BACKGROUND

Artificial neural networks became the backbone engine in computer vision, voice recognition and other applications of artificial intelligence and pattern recognition. Rapid increase of available computation power allows to tackle problems of higher complexity, which in turn requires novel approaches in network architectures, and algorithms. Emerging applications such as autonomous vehicles, drones, robots and other multi-sensor systems, smart-city, smart home, Internet of Things as well as device to device and device to cloud connectivity enable novel computational solutions, which improves the system efficacy.

In some known neural network systems, the entire neural network is trained on a specific dataset prior to deployment into a product. Then, the trained network is deployed and executed, either on a device or on cloud resources. In the latter case the device usually transmits its relevant sensor data, such as a video or audio stream, to the cloud, and receives from the cloud the results of the neural network process.

This approach causes rigidity in the functionality of the trained network, which was trained on the often outdated training set collected prior to deployment. Further, this approach causes rigidity in the utilization of the hardware platform, which may become insufficient for network computations, or to the contrary, may be under-utilized by the network.

[PathNet] Describes somewhat related approach, where a big neural network has multiple modules in each layer of the network, where an output of any module from layer N can be connected to an input of any module from Layer N+1. A specific path between the modules can be selected and/or configured, thus defining a specific network. In such, systems, the network can be trained by supervised training along random paths. The performance of different paths is evaluated by the validation set, followed by selection and freezing of the best-performing path, and re-initialization of the parameters on other modules. This, according to the authors, allows more efficient application of genetic algorithms, where the best trained instances of the network are memorized.

### SUMMARY

According to an aspect of some embodiments of the present invention, there is provided a modular neural network system comprising: a plurality of neural network modules; and a controller configured to select a combination of at least one of the neural network modules to construct a neural network, dedicated for a specific task.

Optionally, sonic of the modules are trained with at least partially different sets of input data.

Optionally, some of the modules have different sizes or different amounts of internal parameters.

Optionally, each of the different training input data sets reflect different operation conditions.

Optionally, the controller is configured to receive parameters of the task and to select the combination based on the received parameters and according to known training conditions, wherein the parameters comprise at least one of: type of input data, type of task and available resources.

Optionally, some of the network modules depend on input data and some are independent from input data, wherein the controller is configured to: select a sensor-dependent network module according to a type of input data, and construct a dedicated neural network by using the sensor-dependent network module for sensor-dependent levels of the task, and a sensor-independent network module for sensor-independent levels of the task.

Optionally, the controller is configured to execute at least some of the selected network modules on different platforms.

Optionally, the controller is configured to dynamically change which network modules are executed on which platform according to utilization of at least one of: computation resources, energy and communication resources.

Optionally, the controller is configured to select which network modules are executed on which platform according to data privacy requirements, by executing modules that process privacy-sensitive data on a local device and executing modules that process privacy-insensitive data on a remote platform.

Optionally, the controller is configured to obtain a confidence level of a result of a network module process, and to execute a process with a low confidence level of results by modules and/or platforms that provide stronger computational power.

Optionally, at least one of the network modules is trained according to a result and/or labeled data obtained by another one of the network modules.

Optionally, the controller is configured to construct multiple different dedicated neural networks .for a same task, to obtain a rank for results of each of the dedicated neural networks, and to select a dedicated neural network for the task according to the obtained rank.

Optionally, the system further comprising a processor configured to execute code instructions for: analyzing a task to be performed; deciding required properties of a dedicated neural network for performing the task; identifying suitable network modules according to the known training conditions; and linking the identified network modules to construct a dedicated network.

Optionally, the controller is configured to calculate the amount of traffic or computations within layers of the neural network, and to adjust distribution of the network modules between available hardware resources based on a calculated amount of computations within each layer of the network or an amount of data traffic between the layers process of the network.

Optionally, the controller is configured to partition the neural network to a separate network module where the data is sufficiently disassociated with the original input data, to process the sufficiently disassociated data on a remote server.

Optionally, the controller is configured to partition the neural network to separate network modules where processing of data sets from different sources is united into third network module.

### BRIEF DESCRIPTION OF THE DRAWINGS

Some non-limiting exemplary embodiments or features of the disclosed subject matter are illustrated in the following drawings.

In the drawings:

FIG. 1A is a schematic illustration of a system for managing a modular neural network according to some embodiments of the present invention;

FIG. 1B is a schematic illustration of a non-binding example of a neural network, according to some embodiments of the present invention.

FIG. 2 is a schematic flowchart illustrating a method for managing a modular neural network according to some embodiments of the present invention;

FIG. 3 is a schematic illustration of an exemplary distributed modular neural network according to some embodiments of the present invention.

FIG. 4 is a schematic illustration of an exemplary convolutional neural network for object detection in images, illustrating calculation of amounts of computations in the layers and information flow between the layers, according to some embodiments of the present invention.

FIG. 5A, 5B and 5C are schematic illustrations of exemplary convolutional neural network architectures, according to some embodiments of the present invention.

With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Identical or duplicate or equivalent or similar structures, elements, or parts that appear in one or more drawings are generally labeled with the same reference numeral, optionally with an additional letter or letters to distinguish between similar entities or variants of entities and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

As mentioned above, some layered neural network systems have multiple modules in each layer of the network, where an output of any module from layer N can be connected to an input of any module from Layer N+1. A specific path between the modules can be selected and/or configured, thus defining a specific network. In such systems, the network can be trained by supervised training along random paths. The performance of different paths is evaluated by the validation set, followed by selection and freezing of the best-performing path, and re-initialization of the parameters on other modules. This results in only one network for all the cases, which configuration is frozen upon completion of the training.

In contrast, in some embodiments of the present invention, different modules are trained for different learning tasks, based on corresponding different datasets. Therefore, selection of specific combination of modules allows controlled and dynamic configuration of the resulting network for a specific task, by selecting from the combinatorial amount of possible different configurations and tasks.

Some embodiments of the present invention may include a system, a method, and/or a computer program product. The computer program product may include a tangible non-transitory computer readable storage medium (or media) having computer readable program instructions thereon for causing a processor to carry out aspects of the present invention. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including any object oriented progamming language and/or conventional procedural programming languages.

Before explaining at least one embodiment of the invention in detail, it is to be so understood that the invention is not necessarily limited in its application to the details of construction and the arrangement of the components author methods set forth in the following description and/or illustrated in the drawings and/or the Examples. The invention is capable of other embodiments or of being practiced or carried out in various ways.

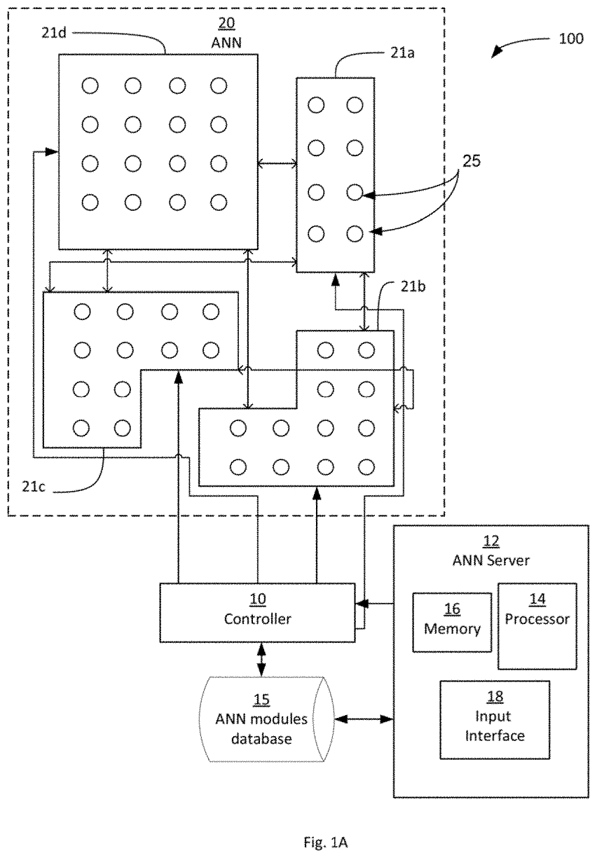

Reference is now made to FIG. 1A, which is a schematic illustration of a system 100 for managing a modular neural network according to some embodiments of the present invention. System 100 includes an artificial neural network (ANN) cluster 20, a controller 10 and a server 12. Server 12 may include at least one processor 14, a non-transitory memory 16 and an input interface 18.

ANN cluster 20 may include a modular distributed ANN, including a plurality of distributed sub-networks, for example distributed network modules 21a-21d. Although FIG. 1 shows four network modules, the invention is not limited in this respect and ANN cluster 20 may include any suitable number of distributed network modules. Each of the network modules 21a-21d may be trained separately and/or under different conditions and or different kind and/or set of input data. The different sets of input data may correspond to and/or reflect different tasks and/or different operation conditions in which a task is performed, or the different trade-offs between the network accuracy and size (computational burden). Accordingly, each of the network modules 21a-21d may have other known properties, implied and/or affected by the different input training data sets, For example, the training conditions and/or types may be stored in a module database 15 with relation to identities of the corresponding network modules.

For example, the different modules for initial layers of convolutional neural network for object recognition may correspond to different illumination or weather conditions, while deeper layers may correspond to different object classes. Modules with larger layers may correspond to more accurate networks, which demand more computations, while smaller layers may correspond to the faster but possibly less accurate networks.

In some embodiments of the present invention, memory 16 stores code instructions executable by processor 14. When executed, the code instructions cause processor 14 to carry out the methods described herein. According to some embodiments of the present invention, processor 14 executes methods for generation and management of modular distributed ANN.

Processor 14 may send instructions to controller 10, which may select, based on the received instructions, at least one of network modules 21a-21d, and or operate a combination of the, selected network modules as a dedicated neural network, for example for executing a neural network process such as classification of data by the resulting dedicated neural network.

Further reference is now made to FIG. 1B, which is a schematic illustration of a non-binding example of a neural network 100a, according to some embodiments of the present invention. Network 100a includes, for example, modules 120-125, 130 and 160 processing the information gathered from a sensor 110, wherein module 125 is an instance, selected from the set of modules 125B-125Z, and module 130 is selected from the set of modules 130B-130Z, while module 160 is selected from the set of modules denoted by 160B.

Sensor 110 may be, as a non-limiting example, an image senor, layers 120-125, and 130 may be convolutional layers, while layer 160 may be a fully connected layer. Modules 125B-125Z may be trained for different illumination conditions, modules 130B-130Z for different object classes, while modules 160B, may be trained for different trade-offs between the quality of object recognition and cost of computations.

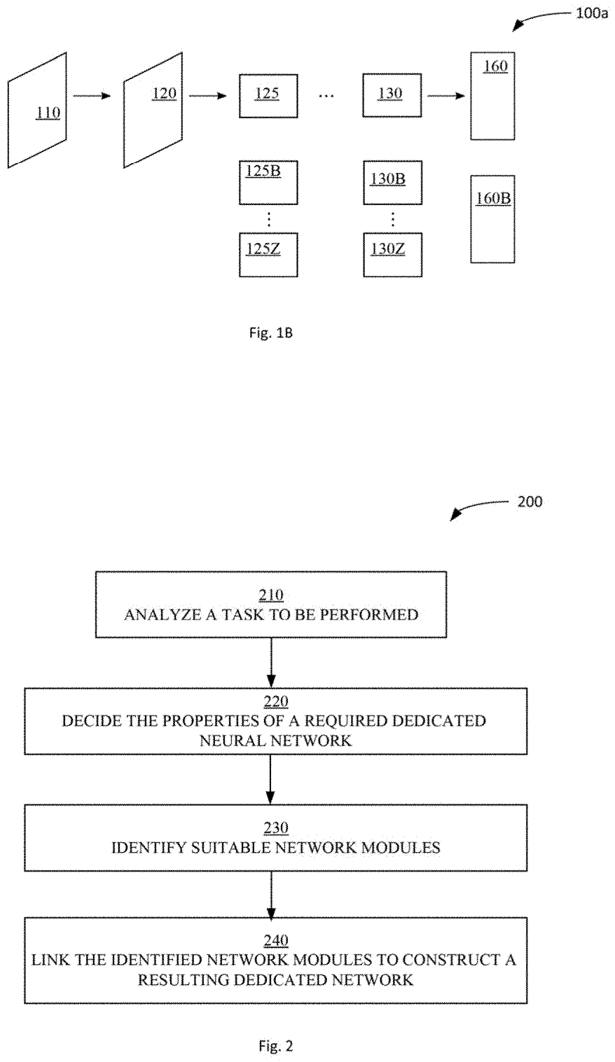

Further reference is now made to FIG. 2, which is a schematic flowchart illustrating a method 200 for managing a modular neural network according to some embodiments of the present invention. As indicated in block 210, processor 14 may analyze a task to be performed, for example a requested and required task, the type of input data, and/or available resources. As indicated in block 220, based on the analyzed task, processor 14 may decide the properties of a required neural network, suitable for performance of the task. As indicated in block 230, based on the decision, controller 10 and/or processor 14 may identify suitable network modules, for example by finding the corresponding properties of the modules stored in database 15. As indicated in block 240, controller 10 may link the identified network modules to construct a resulting dedicated network.

In some embodiments of the present invention, processor 14 executes two or more different modular networks, i.e. different combinations of neural network modules, to perform a neural network process with the same input data. Processor 14 may choose between the modular networks according to determined criteria, for example after receiving the results of the neural network process from each of the modular networks. For example, processor 14 may receive from each of the modular networks a result of the process, calculate a confidence level for each of the results, and rank the results accordingly and/or select the modular network that provides the better confidence level. For example, processor 14 may receive votes about the results, and rank the results and/or select the modular network that received the most positive votes for its result. This way, system 100 may obtain the most efficient dedicated network of the possible modular networks. Further, system 100 may facilitate evolution of the modular networks, where only the most reliable combinations and/or modules are selected and further trained and evolve.

In some embodiments, by executing multiple different modular network combinations for performing the same task, with the same or with different input sensor data, the different modular network combinations may be used for cross-training, in which results of one network are used for training or re-training of another network.

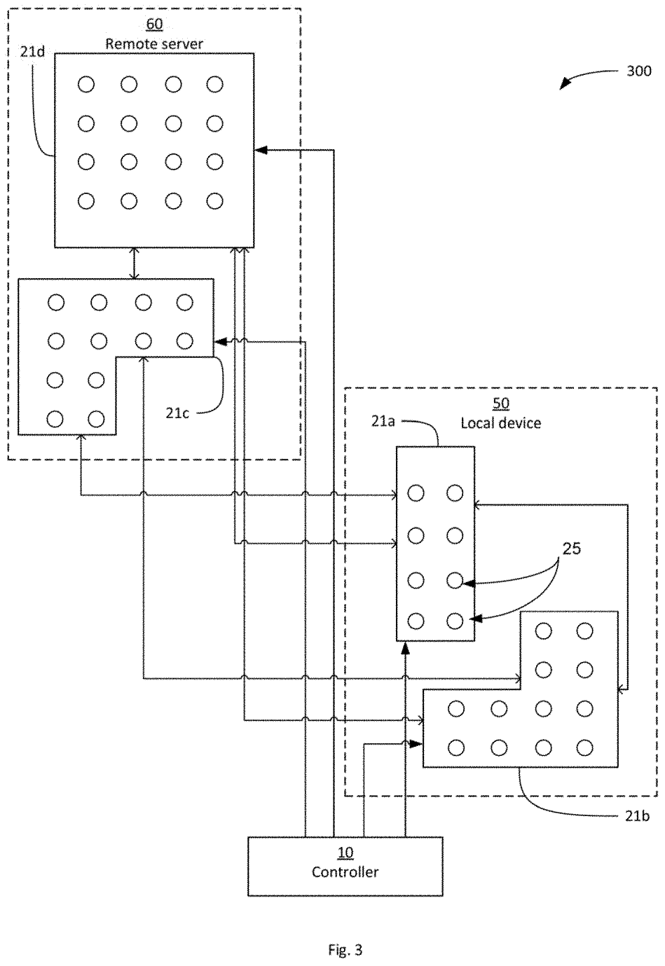

Reference is now made to FIG. 3, which is a schematic illustration of an exemplary distributed modular neural network 300, according to some embodiments of the present invention. In some embodiments, some of network modules 21a-21d are executed in a distributed manner, i.e. on different devices and/or platform. For example, some of modules 21a-21d are executed on a local device 50, such as a sensing or detection unit, and some are executed on a remote server 60. For example, in a dedicated modular network, some of the network modules may be executed in a distributed manner, i.e. on different devices and/or platforms. By executing a modular neural network in a distributed manner, system 100 may save and/or manage computation resources, energy and/or network traffic on device 50 or on multiple devices. For example, network modules that process privacy-sensitive data and/or transmit large amounts of data may be executed on local device 50, while other modules included in the same modular neural network may be executed remotely, for example on server 60. For example, network modules that process heavy computations and/or process privacy insensitive data may be executed on remote server 60.

In some embodiments of the present invention, controller 10 may adapt distributed modular neural network 300 and change dynamically which of the network modules are executed on which device or platform. For example, controller 10 may adapt distributed modular neural network 300 based on the available computational and/or communication resources on each device and/or platform, and/or based on the nature of the task and required solution.

In some embodiments of the present invention, the amount of traffic or computations within layers of the neural network is calculated and/or estimated. The distribution of the network modules between available hardware resources may be optimized and/or adjusted, for example, based on a calculated and/or estimated amount of computations within each layer of the network and/or amount of data traffic between the layers the network.

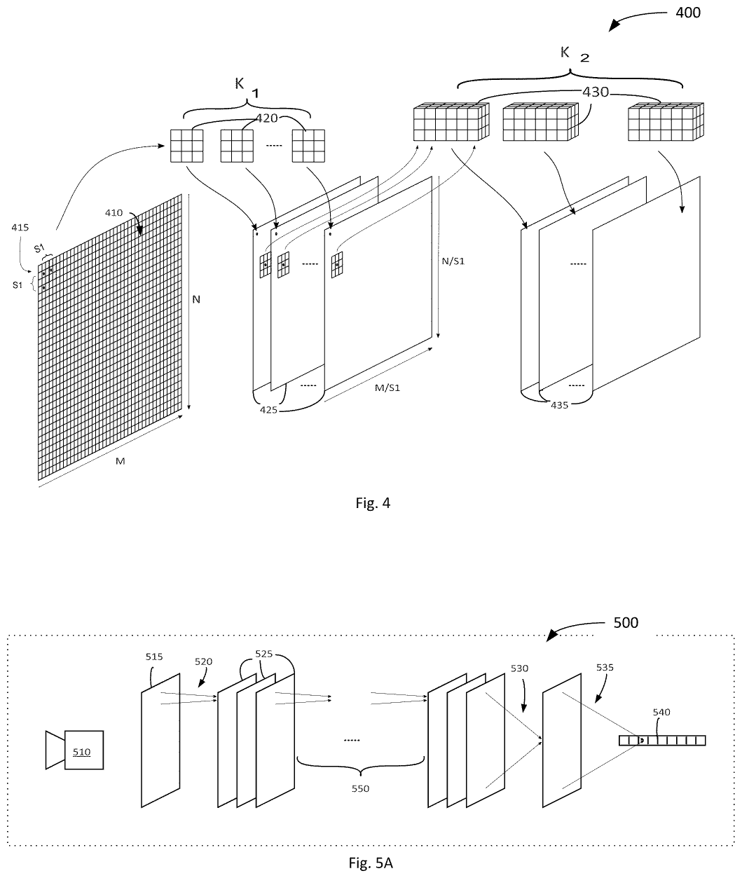

Reference is now made to FIG. 4, which is a schematic illustration of an exemplary neural network architecture 400, according to some embodiments of the present invention. Network architecture 400 may be carried out by at least one processor 14. Network architecture 400 may be a convolutional neural network architecture for image processing. However, the invention is not limited to image processing or to any specific kind of neural network process.

Network architecture 400 may include receiving at processor 14 input data array 410, for example an input image. For example, in case network architecture 400 includes a convolutional network process for detecting objects in the video stream, input data array 410 may include a single frame out of a video stream. Input data array 410 may have N rows and M column, i.e. frame size of M×N. For example, in case of HD (High Definition) image data, the frame size may be of 1920×1080. A new frame can be obtained and/or received in a rate of 30 frames per second.

Server 60 may maintain a repository 420 of K1 first layer operator filters, for processing of input data in a first layer of the neural network, and a repository 430 of K2 second layer operator filters, for processing of input data in a second layer of the neural network, and so forth. In some embodiments of the present invention, processor 14 may apply on multiple locations on the image data array 410 one of the K1 fibers, for example a 3×3 filter 415 or a filter of any other suitable size. For example, filter 415 may be applied on an upper left corner of the input image, and on two adjacent positions shifted by stride S1 from the first position, as shown in FIG. 4. For example, each filter is a D×D array, for example a 3×3 array, if applied to the gray image, and a D×D×3 array if applied to a color image. The same filter 415 may be applied to a grid of positions spreading along the entire image with a stride S1, producing an array of resulting values of N/S1 rows and M/S1 columns.

Accordingly, in case there, are K1 filters in the first layer filter repository 420, processor 14 may produce K1 corresponding arrays 425 of resulting values, each corresponding to another filter and resulting from applying the filter, and each having a size of M*N(S1*S1). Accordingly, in, case amount of information in an uncompressed input color image of 3 bytes per pixel is M*N*3 bytes, the amount of information in the K1 arrays is K1*M*N(S1\hat{ }2)*B bytes, where B is number of bytes per value in the arrays. Therefore, the amount of computations performed in the first layer is D*D*3*K1*M*N(S1/S1).

On a second layer of the neural network, each of the K2 second layer operator filters may be applied on each of the K1 arrays 425. Each of the K2 second layer operator filters may be of size D×D×K1, for example 3×3×K1 as shown in FIG. 4. Accordingly, processor 14 may produce K2 corresponding arrays 435 of resulting values, each corresponding to another filter and resulting from applying the filter, and each having a size of M*N/(S1\hat{ }2*S2\hat{ }2). Each of the K2 filters performs K1*D*D operations at M/S1/S2)*(N/S1/S2) locations, totaling in D*D*K1*K2*M*N(S1\hat{ }2*S2\hat{ }2) operations, resulting in K2*M*N(S1\hat{ }2*S2\hat{ }2)*8 bytes of information. Knowing the amount of information as well as the amount of computations in each layer allows optimized partitioning of the distributed neural networks, for example between several devices, between a device and a cloud. For example, a front-end sensor may process one or a few first convolutional network modules, wherein a host device may computing rest of the network.

Architecture 400 may continue in multiple layers and/or modules of the neural network, wherein in each layer, respective filters are applied on arrays resulting from the previous layers.

For example, for more difficult neural network computations, controller 10 may utilize a more powerful device and/or platform, particularly for execution of higher level network modules, for example while executing the lower levels on a smaller and/or weaker device.

In some embodiments of the present invention, system 100 is configured to execute neural network processes with various kinds and/or sets of sensors. For example, system 100 may interface with device A and/or with device B, each having different sensors, receive sensor data and execute the modular neural network based on the input sensor data. For example, some of network modules 21a-21d may depend on the kind of sensors from which data is received and/or the kind of sensor data received. Other of network modules 21a-21d may be sensor independent. Processor 14 may identify suitable network modules for a task involving a certain type of device and/or certain set of sensors, for example by finding the corresponding properties of the modules store d in database 15. For sensor-independent levels of the neural network process, processor 14 may use suitable sensor-independent network modules, which may be used with various kinds of devices.

Controller 10 may link the identified network modules with sensor-independent network modules to construct a resulting dedicated network. Thus, system 100 may save neural network volume by using a certain portion of the network for multiple kinds of devices, without the need to provide a whole different network for each different device. In some cases, controller 10 may include a switch to select between sensor-dependent modules of modular neural network 20, for example by linking the selected network module to a sensor-independent module of modular neural network 20. In some embodiments, cross-training may be performed, in which data collected on one device is used for training of network modules executed on another device, thus enriching the pool of labeled training data.

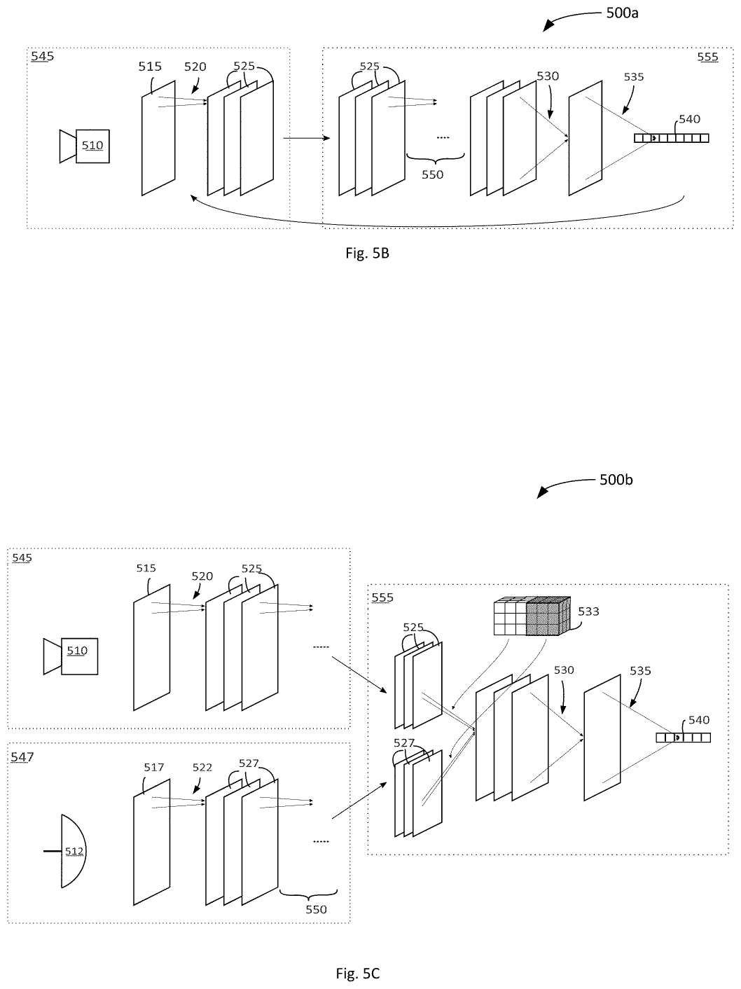

Reference is now made to FIG. 5A, which is a schematic illustration of an exemplary convolutional neural network architecture 500 for object recognition in images, according to some embodiments of the present invention. Network architecture 500 may be carried out by at least one processor 14. Although FIG. 5A shows a particular example of an object recognition process, the principles described herein are applicable to other network architectures, and other machine learning tasks. Processor 14 may receive a pixel array 515, for example via a video camera 510. Pixel array 515 may be a single frame from a video stream acquired by camera 510. Processor 14 may apply convolutional operators of a first convolutional neural layer 520, such as filters K1 described above with reference to FIG. 4, resulting in value arrays 525, such as arrays 425 described above with reference to FIG. 4 The process may continue in multiple intermediate layers 550 and in layers 530 and 535, wherein a last layer 535 results in an array 540 of probabilities of object classes.

Reference is now made to FIG. 5B, which is a schematic illustration of an exemplary neural network architecture 500a including an optional distribution of the network modules according to some embodiments of the present invention. Network architecture 500a may include a first network module 545 and a second network module 555. In some embodiments, first network module 545 is processed on a local device, for example a smart-phone, while second network module 555 is processed on another server, for example on a remote and/or cloud server. For example, first network module 545 is processed on a sensor device and/or includes, for example, a first layer or several convolutional layers. Thus, for example, network architecture 500a may preserve privacy for applications such as safety alarm in a hospital's restroom, or security alarm, since the pixel 345 array 515 may contain explicit image. Arrays 525 contain the convolutional filter resulting values, which lose correlation with the original image data, the deeper the layer is in the neural network. Network architecture 500a may be partitioned where the data is sufficiently disassociated with the original input data array 515, so that the rest of the network is included in second network module 555, which may be processed on another server.

Reference is now made to FIG. 5C, which is a schematic illustration of an exemplary neural network architecture 500b including an optional distribution of the network modules according to sonic embodiments of the present invention. Network architecture 5001 may include a first network module 545, a second network module 547 and a third network module 555. In some embodiments, first and second network modules 545 and 547 are processed on a local device or each on a different local device, and/or include, for example, a first layer or several convolutional layers. Third network module 555 may be processed on a remote server, for example on a cloud. For example, first network module 545 is processed on a sensor device, for example camera 510. First network module 545 may receive sensor data array 515, for example from camera 510, processes it by filters 520 and generate arrays 525, including convolutional filter resulting values. For example, second network module 547 is processed on another device, for example a RADAR device 512. Second network module 547 may receive a data array 517, for example from RADAR 512, processes it by filters 522 and generate arrays 527, including convolutional filter resulting values.

In some embodiments, at some stage in the neural network the processing of data 515 and data 517 may be united into third network module 555, for example in layer 529 as shown in FIG. 5C. For example, processor 14 may use in layer 529 a convolutional filter 533 for combination of disjoint heterogeneous networks such as modules 545 and 547. For example, a part of filter 533, colored white in FIG. 5C, is for convolutions with a layer from one network module, and another part of filter 533, colored grey in FIG. 5C, is for convolution with another network module. Additionally, network architecture 500b may be partitioned where the data is sufficiently disassociated with the original input data arrays 515 and 517, so that the rest of the network is included in third network module 555, which may be processed on another server.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors, or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or, operable or operative to achieve the objective.

A device storing and/or comprising a program and/or data constitutes an article of manufacture, Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is, for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A modular neural network system comprising:
a plurality of neural network modules; and
a controller configured to select a combination of at least one of the neural network modules to construct a neural network, dedicated for a specific task,
wherein the controller is configured to construct multiple different dedicated neural networks for a same task, to obtain a rank for results of each of the dedicated neural networks, and to select a dedicated neural networks for the task according to the obtained rank.

2. The neural network of claim 1, wherein some of the modules are trained with at least partially different sets of input data.

3. The neural network of claim 1, wherein some of the modules have different sizes or different amounts of internal parameters.

4. The neural network of claim 1, wherein each of the different training input data sets reflect different operation conditions.

5. The neural network system of claim 1, wherein the controller is configured to receive parameters of the task and to select the combination based on the received parameters and according to known training conditions, wherein the parameters comprise at least one of: type of input data, type of task and available resources.

6. The neural network system of claim 1, wherein some of the network modules depend on input data and some are independent from input data, wherein the controller is configured to:
select a sensor-dependent network module according to a type of input data; and
construct a dedicated neural network by using the sensor-dependent network module for sensor-dependent levels of the task, and a sensor-independent network module for sensor-independent levels of the task.

7. The neural network system of claim 1, wherein the controller is configured to execute at least some of the selected network modules on different platforms.

8. The neural network system of claim 5, wherein the controller is configured to dynamically change which network modules are executed on which platform according to utilization of at least one of: computation resources, energy and communication resources.

9. The neural network system of claim 5, wherein the controller is configured to select which network modules are executed on which platform according to data privacy requirements, by executing modules that process privacy-sensitive data on a local device and executing modules that process privacy-insensitive data on a remote platform.

10. The neural network system of claim 5, wherein the controller is configured to obtain a confidence level of a result of a network module process, and to execute a process with a low confidence level of results by modules and/or platforms that provide stronger computational power.

11. The neural network system of claim 1, wherein at least one of the network modules is trained according to a result and/or labeled data obtained by another one of the network modules.

12. The neural network system of claim 1, further comprising a processor configured to execute code instructions for:
analyzing a task to be performed;
deciding required properties of a dedicated neural network for performing the task;
identifying suitable network modules according to the known training conditions; and
linking the identified network modules to construct a the dedicated network.

13. The neural network system of claim 1, wherein the controller is configured to calculate the amount of traffic or computations within layers of the neural network, and to adjust distribution of the network modules between available hardware resources based on a calculated amount of computations within each layer of the network or an amount of data traffic between the layers the network.

14. The neural network system of claim 1, wherein the controller is configured to partition the neural network to a separate network module where the data is sufficiently disassociated with the original input data, to process the sufficiently disassociated data on a remote server.

15. The neural network system of claim 1, wherein the controller is configured to partition the neural network to separate network modules where processing of data sets from different sources is united into third network module.
